(19) United States
(12) Patent Application Publication
(10) Pub. No.: US 2011/0139157 A1
(43) Pub. Date: Jun. 16, 2011

(54) System and Method of Delivering Emergency Breathable Gas Supply to Underground Mines

(75) Inventor: David A. Hussey, Glenwood Springs, CO (US)

(73) Assignee: MICON, Glassport, PA (US)

(21) Appl. No.: 12/966,223

(22) Filed: Dec. 13, 2010

Related U.S. Application Data
(60) Provisional application No. 61/286,073, filed on Dec. 14, 2009.

(51) Int. Cl. A62B 33/00

(52) U.S. Cl. 128/205.26

(57) ABSTRACT

A system for delivering a sustainable emergency supply of breathable gas to a chamber in an underground mine includes a source of breathable gas, a pipe system for transporting the breathable gas buried below the mine floor in fluid connection with the gas source, and a regulator that controls the rate at which air is released from the pipe system.

### CROSS REFERENCE TO RELATED APPLICATION

This application claims the benefit of U.S. Provisional Application No. 61/286,073, filed Dec. 14, 2009, herein incorporated by reference.

### BACKGROUND OF THE INVENTION

1. Field of the Invention

This invention relates to a system and method for delivering a breathable gas supply to underground mines in the event of an emergency that traps workers underground and/or contaminates the underground air with toxic gases.

2. Description of Related Art

Mining ventilation is a significant safety concern for underground workers. Poor ventilation of the mines causes exposure to harmful gases, heat and dust inside sub-surface mines. Various methods are known in the art for providing adequate ventilation, including dilution (ventilation), capture before entering the host air stream (methane drainage), or isolation (seals and stoppings). In the event of an underground explosion, however, the primary ventilation system can fail, exposing workers to potentially fatal concentrations of airborne contaminants.

At present, workers have few options in the aftermath of an explosion: attempt to escape or barricade themselves and await rescue. Although every underground worker's preferred option is to escape, fire or debris from the explosion or severe injury may prevent them from doing so. Life-sustaining supplies can be pre-positioned throughout the mine to provide continued sustenance to trapped workers, but at present there is no effective way to provide a dependable, continuous supply of breathable gas in the immediate aftermath of a blast. An underground explosion is also likely to damage any exposed ductwork in the passageway that might be relied on to transport breathable gas to trapped workers. In the time required to drill a borehole from the surface of the mine to the underground passageway, the concentration of carbon monoxide and other toxic gases may reach fatal levels. Accordingly, there exists a need for a system and method for delivering a continuous source of breathable gas that is accessible to underground workers at various locations within the mine and that can be activated immediately following an explosion.

### SUMMARY OF THE INVENTION

The present invention includes a system for delivering a sustainable emergency supply of a breathable gas to a chamber in an underground mine including a passageway having a ceiling and a floor. The system includes a source of breathable gas located exterior to the chamber, a pipe system in fluid communication with the breathable gas source for transporting a supply of breathable gas to the chamber, and at least one regulator for controlling the rate at which the breathable gas is released from the pipe system. An exemplary breathable gas source includes, but is not limited to, a compressor located at ground level and exterior to the mine, and an exemplary breathable gas includes, but is not limited to, atmospheric air and oxygen-enriched air. The pipe system is buried below the surface of the mine floor to protect the pipes transporting a breathable gas against damage resulting from an explosion, collapse, or combination thereof, as well as any damage that might result from the use of underground excavating equipment. A suitable location of the regulator is in the chamber.

The present invention further includes a method of delivering sustenance to at least one person occupying a chamber in an underground mine. The method includes providing a source of breathable gas, transporting the breathable gas through a pipe system in fluid communication with the gas source, and controlling the rate at which the breathable gas is released from a regulator in the chamber.

Other features of the invention will become apparent to those of ordinary skill in the art upon reading and understanding the following detailed description, taken with the accompanying drawings, wherein like reference numerals represent like elements throughout.

### BRIEF DESCRIPTION OF THE DRAWINGS

FIG. 1 is a plan cross-sectional view of a mine entry incorporating the system of the present invention;

FIG. 2 is an elevational cross-sectional view of a chamber in the entry showing the placement of a borehole drilled downward from above the chamber;

FIG. 3A is an elevational cross-sectional view of a mine entry according to the present invention; and

FIG. 3B is an elevational cross-sectional view of a mine entry according to another embodiment of the present invention.

### DETAILED DESCRIPTION OF THE INVENTION

For purposes of the description hereinafter, spatial or directional terms shall relate to the invention as it is oriented in the drawing figures. However, it is to be understood that the invention may assume various alternative variations, except where expressly specified to the contrary. It is also to be understood that the specific apparatus illustrated in the attached drawings, and described in the following specification, is simply an exemplary embodiment of the invention. Hence, specific dimensions and other physical characteristics related to the embodiments disclosed herein are not to be considered as limiting, unless otherwise indicated.

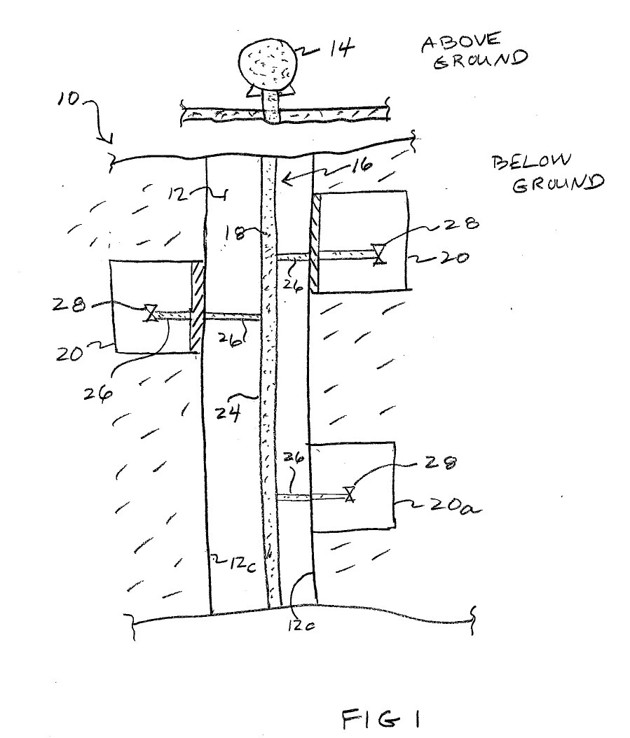

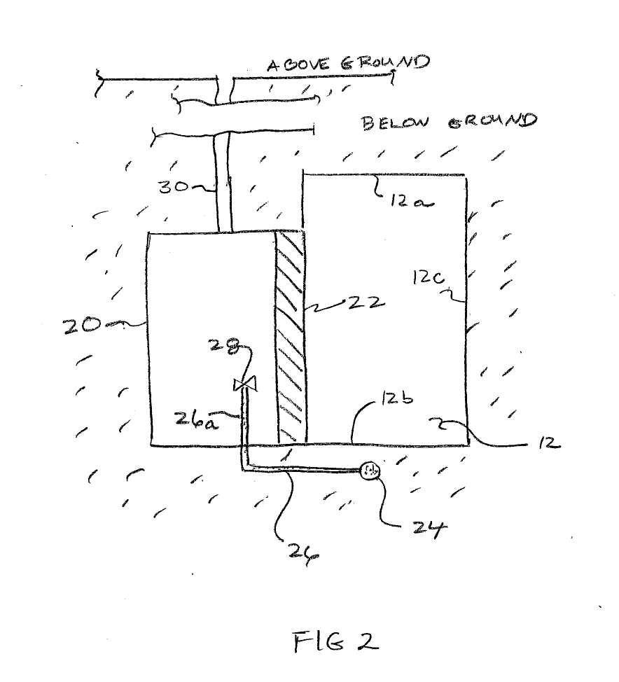

With reference to FIGS. 1 and 2, a system of delivering a supply of breathable gas 18 to a chamber 20 in an underground mine 10 is shown. The mine 10 includes a passageway 12 having a ceiling 12a, a floor 12b, walls 12c, and at least one chamber 20.

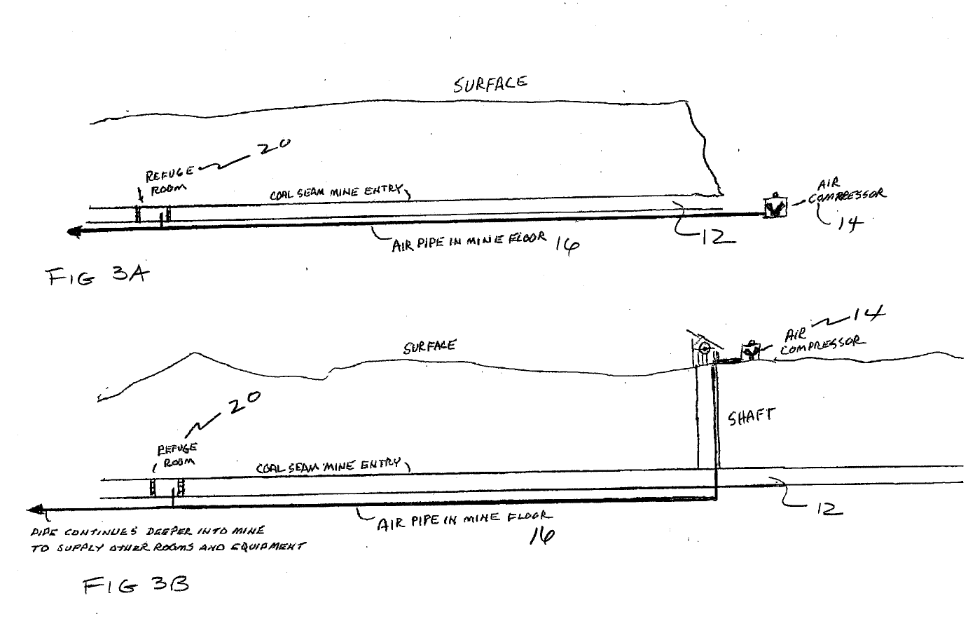

A breathable gas source 14 is located exterior to the chamber 20 and may be positioned above ground. One suitable breathable gas source is a compressor. A pipe system 16 is in fluid connection with the breathable gas source 14 and the chamber 20 and is buried beneath the surface of the mine floor 12b to protect the pipe system 16 from damage. Referring to FIGS. 3A and 3B, gas source 14 may be located below ground or at the surface. The pipe system 16 may be buried a few inches below the floor surface, such as two or three inches or even deeper. The depth at which the pipe system 16 is buried may be determined at least in part by the anticipated disturbances to the floor 12b, for example by equipment traveling thereover. The pipe system 16 may be installed below the floor 12b by digging trenches (e.g., with a trenching tool), laying the pipe system 16 in the trenches and covering over the pipe system 16 to replace the floor 12b. It should be appreciated that the pipe system may be buried underneath floor 12b or within walls 12c of the passageway 12 or the like. A regulator 28 (e.g., a valve) controls the rate at which the breathable gas 18 is released from the pipe system 16 into the chamber 20. In a normal mode, the regulator 28 is closed and no gas is provided therefrom. Chamber 20 includes a closeable barrier 22, such as a door, and an optional vent (not shown). Some chambers 20 may include a barrier (e.g. a door). Other chamber(s) 20a have no barrier, which is then constructed upon occupancy of the chamber 20a as described below.

In one embodiment, the pipe system 16 comprises a main pipe 24 and at least one branch pipe 26. For example, main pipe 24 may have an internal diameter of about eight inches and branch pipes 26 may have internal diameters of about two inches. The pipe system 16 may include a plurality of branch pipes 26 extending into separate chambers 20. In this manner, pipe system 16 is installed and available for use at any time. Importantly, by burying pipe system 16 underneath the floor 12b and/or within the walls 12c of underground passageway 12, the pipe system 16 remains unaffected by forces associated with an explosion, roof failure, or the like.

The breathable gas source 14 is capable of producing sufficient gas flow to displace gases preexisting in chamber 20 (e.g., CO) and sustaining at least one person for an extended period of time. A vent may be provided in a surface of the chamber to allow gas to exit the chamber while breathable gas is provided through the pipe system 16. Alternatively, barrier 22 may allow venting therethrough. Branch pipe 26 extends beyond the barrier 22 to a position underneath the floor 12b or the surrounding rock walls of the chamber 20, where branch pipe 26 extends into the chamber 20. An exposed end 26a of branch pipe 26 may extend into chamber 20 through floor 12b, as shown, or through side walls of chamber 20. The walls, ceiling, and floor of chamber 20 may be exposed rock surface or an engineered structure (panels, blocks, etc.). Breathable gas released from exposed end 26a of branch pipe 26 purges the preexisting contaminating gases trapped behind the closeable barrier 22, thereby sustaining at least one person occupying the chamber 20.

The system of the present invention may be used during an emergency when underground personnel require a safe environment. Personnel entering a chamber 20 activate regulator 28 to begin flow of fresh breathable gas supply 18 and barrier 22 is closed or constructed. Any undesired gas preexisting in the chamber 20 or produced during respiration (e.g., CO₂) may be expelled by the positive pressure of the gas supply 14 and exits the chamber 20, such as through the vent or gaps in the surrounding rock. Regulator 28 may be operated to control the rate at which the breathable gas 18 is released into chamber 20. With reference to FIG. 2, this method can further include drilling a borehole 30 into the chamber 20 from above ground to create access into the chamber 20 for providing additional sustenance through the borehole 30, such as food, water, communications systems, and the like.

The invention has been described with reference to the desirable embodiments. Modifications and alterations will occur to others upon reading and understanding the preceding detailed description. It is intended that the invention be construed as including all such modifications and alterations insofar as they come within the scope of the appended claims or the equivalents thereof.

The invention claimed is

1. A system for delivering an emergency breathable gas supply to at least one chamber in an underground mine comprising a mine passageway having a ceiling and a floor, comprising:
a breathable gas source located exterior to said chamber;
a pipe system in fluid communication with said gas source for transporting a supply of breathable gas to said chamber, wherein said pipe system is buried below the surface of the mine floor to protect said pipe system from damage; and
at least one regulator for controlling the rate at which breathable gas is released from said pipe system into said chamber.

2. The apparatus of claim 1, wherein said pipe system comprises a main supply pipe and at least one branch pipe.

3. The apparatus of claim 1, wherein said main pipe has an internal diameter of at least 8 inches and said branch pipe has an internal diameter of at least 2 inches.

4. The apparatus of claim 2, wherein said at least one branch pipe comprises a plurality of branch pipes and each of said plurality of branch pipes extend into a separate chamber.

5. The apparatus of claim 2, wherein said regulator is positioned at a terminal end of said branch pipe.

6. The apparatus of claim 1, wherein said breathable gas source is capable of producing sufficient gas flow to sustain a person for an extended period of time.

7. The apparatus of claim 1, wherein said breathable gas source is capable of producing sufficient gas flow to displace gases preexisting in said chamber.

8. The apparatus of claim 1, wherein said breathable gas is air.

9. The apparatus of claim 1, wherein said chamber further comprises a closeable barrier.

10. A method of providing sustenance to at least one person occupying a chamber in an underground mine comprising a mine passageway with a ceiling and a floor, comprising the steps of:
providing a breathable gas source located exterior to said chamber;
transporting a supply of breathable gas from said gas source along a pipe system in fluid communication with said chamber, wherein said pipe system is buried below the mine floor to protect said pipe from damage; and
controlling the rate at which the breathable gas is released from a regulator located in said chamber.

11. The method of claim 10, further comprising the step of providing sufficient breathable gas flow to displace gases preexisting in said chamber.

12. The method of claim 10, further comprising the step of accessing the chamber from above by drilling a borehole downward into the chamber.

13. The method of claim 10, further comprising the step of providing additional sustenance through said borehole.
